(19) United States
(12) Patent Application Publication
(10) Pub. No.: US 2018/0223645 A1
(43) Pub. Date: Aug. 9, 2018

(54) Electromagnetically Transmissive Directional Antenna Shield

(71) Applicant: Halliburton Energy Services, Inc., Houston, TX (US)

(72) Inventors: Jin Ma, Singapore (SG); Burkay Donderici, Houston, TX (US); Glenn Andrew Wilson, Houston, TX (US)

(73) Assignee: Halliburton Energy Services, Inc., Houston, TX (US)

(21) Appl. No.: 15/748,843

(22) PCT Filed: Oct. 12, 2015
(86) PCT No.: PCT/US15/55077

§ 371 Date: Jan. 30, 2018

(51) Int. Cl. E21B 47/01; E21B 47/12

(52) U.S. Cl. CPC E21B 47/011; H01Q 1/42; E21B 47/122

(57) ABSTRACT

A metal cylinder defines a longitudinal axis and has a plurality slots. Each slot has the same dimensions along two perpendicular axes through a centroid of the slot. The plurality of slots is azimuthally periodic relative to the longitudinal axis of the metal cylinder and axially periodic relative to the longitudinal axis of the metal cylinder.

### BACKGROUND

Resistivity tools, used in the oil field in logging-while-drilling (LWD) systems, measurement-while-drilling (MWD) systems, wireline systems, and slickline systems, may use tilted loop antennae. Such antennae typically use a coil of wire wound around the body of the tool. It is a challenge to protect the tilted loop antennae and other components of the resistivity tool with a shield without unduly affecting the magnitude or direction of electromagnetic fields generated by such antennae.

### BRIEF DESCRIPTION OF THE DRAWINGS

FIG. 1 is an elevation view of an illustrative LWD or MWD environment.

FIG. 2 is an elevation view of an illustrative wireline or slickline logging environment.

FIG. 3 is a plan view of a Geological Mapping (GM) tool sub.

FIG. 4 is a plan view of a GM tilted coil antenna-bobbin on a GM tool sub.

FIG. 5 is a plan view of the GM tilted coil antenna-bobbin of FIG. 4 with the bobbin removed to show soft magnetic material (e.g. ferrite) placed between the coil and the tool body.

FIG. 6 is a chart illustrating the directionality of the dipole created by the coil of FIG. 5.

FIG. 7 is a plan view of an electromagnetically transmissive shield that includes one line of circular holes cut into a metal cylinder that covers the antenna system where the circular holes trace the coil.

FIG. 8 is a chart illustrating the directionality of the antenna system with the electromagnetically transmissive shield shown in FIG. 7.

FIG. 9 is a plan view of an electromagnetically transmissive shield that includes one line of square holes cut into a metal cylinder that covers the antenna system, where the square holes are aligned with the tool axis and trace the coil.

FIG. 10 is a chart illustrating the directionality of the antenna system with the electromagnetically transmissive shield shown in FIG. 9.

FIG. 11 is a plan view of an electromagnetically transmissive shield that includes two or more rows of circular holes cut into a metal cylinder that covers the antenna system.

FIG. 12 is a chart illustrating the directionality of the antenna system with the electromagnetically transmissive shield shown in FIG. 11.

FIG. 13 is a plan view of an electromagnetically transmissive shield that includes two or more rows of square holes cut into a metal cylinder that covers the antenna system, where the square holes are aligned with the tool axis and trace the coil.

FIG. 14 is a chart illustrating the directionality of the antenna system with the electromagnetically transmissive shield shown in FIG. 13.

FIG. 15 is a plan view of an electromagnetically transmissive shield that includes a periodic array of circular holes cut into a metal cylinder that covers the antenna system.

FIG. 16 is a chart illustrating the directionality of the antenna system with the electromagnetically transmissive shield shown in FIG. 15.

FIG. 17 is a plan view of an electromagnetically transmissive shield that includes a periodic array of square holes cut into a metal cylinder that covers the antenna system, where the square holes are aligned with the tool axis.

FIG. 18 is a chart illustrating the directionality of the antenna system with the electromagnetically transmissive shield shown in FIG. 17.

FIG. 19 is a plan view of an example of an electromagnetic transmissive shield that includes multiple axially-aligned slots cut into a metal cylinder in which dipole directionality is not preserved.

FIG. 20 is a chart illustrating the directionality of the antenna system with the electromagnetically transmissive shield shown in FIG. 19.

FIG. 21 is a plan view of an example of an electromagnetic transmissive shield that includes three rows of nine rectangular slots cut into a metal cylinder in which dipole directionality is not preserved.

FIG. 22 is a chart illustrating the directionality of the antenna system with the electromagnetically transmissive shield shown in FIG. 21.

FIG. 23 is a plan view of an electromagnetic transmissive shield that includes a row of 9 slots cut into a metal cylinder in which dipole directionality is not preserved.

FIG. 24 is a chart illustrating the directionality of the antenna system with the electromagnetically transmissive shield shown in FIG. 23.

FIG. 25 is a plan view of an electromagnetic transmissive shield that includes a band of curved rectangular slots cut into a metal cylinder in which dipole directionality is not preserved.

FIG. 26 is a chart illustrating the directionality of the antenna system with the electromagnetically transmissive shield shown in FIG. 25.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Further, while this disclosure describes a land-based production system, it will be understood that the equipment and techniques described herein are applicable in sea-based systems, multi-lateral wells, all types of production systems, all types of rigs, wired drillpipe environments, coiled tubing (wired and unwired) environments, wireline environments, and similar environments.

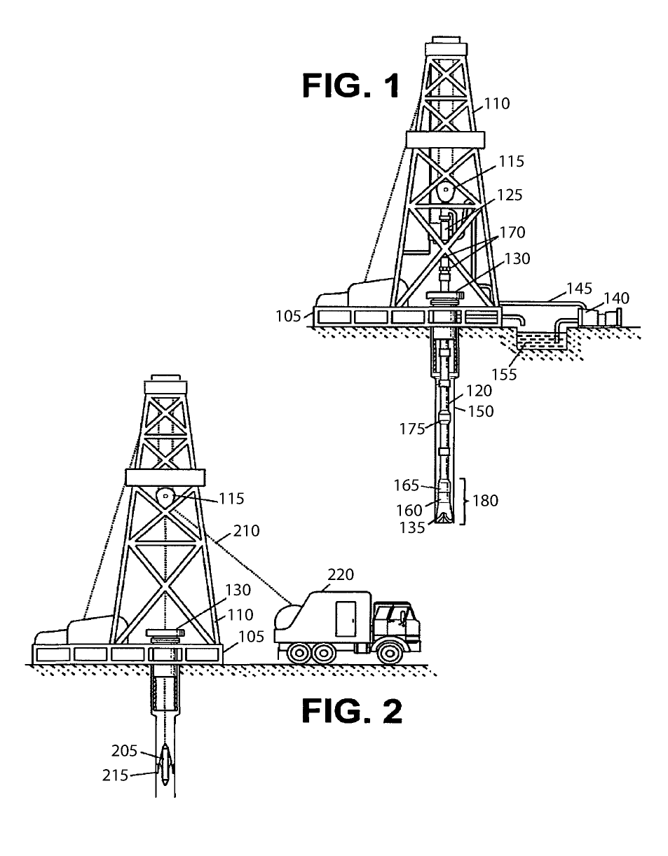

The disclosed tool configurations and operations are best understood in the context of the larger systems in which they operate. Accordingly, an illustrative LWD or MWD environment is shown in FIG. 1. A drilling platform 105 is equipped with a derrick 110 that supports a hoist 115 for raising and lowering a drill string 120. The hoist 115 suspends a top drive 125 that is used to rotate the drill string 120 and to lower the drill string through the well head 130. Connected to the lower end of the drill string 120 is a drill bit 135. The bit 135 is rotated and drilling is accomplished by rotating the drill string 120, by use of a downhole motor near the drill bit, or by both methods. Drilling fluid, termed “mud”, is pumped by mud recirculation equipment 140 through supply pipe 145, through top drive 125, and down through the drill string 120 at high pressures and volumes to emerge through nozzles or jets in the drill bit 135. The mud then travels back up the hole via an annulus formed between the exterior of the drill string 120 and the borehole wall 150, through a blowout preventer (not specifically shown), and into a mud pit 155 on the surface. On the surface, the drilling mud is cleaned and then recirculated by recirculation equipment 140. The drilling mud is used to cool the drill bit 135, to carry cuttings from the base of the bore to the surface, and to balance the hydrostatic pressure in the rock formations.

In wells employing acoustic telemetry for LWD or MWD, downhole sensors (including an electromagnetic resistivity logging tool 160) are coupled to an acoustic telemetry transmitter 165 that transmits telemetry signals in the form of acoustic vibrations in the tubing wall of drill string 120. An acoustic telemetry receiver array 170 may be coupled to tubing below the top drive 125 to receive transmitted telemetry signals. One or more repeater modules 175 may be optionally provided along the drill string to receive and retransmit the telemetry signals. The repeater modules 175 include both an acoustic telemetry receiver array and an acoustic telemetry transmitter configured similarly to receiver array 170 and the transmitter 165.

The electromagnetic resistivity logging tool 160 may be integrated into the bottom hole assembly (BHA) 180 near the bit 135. As the bit extends the borehole through the formations, downhole sensors collect measurements relating to various formation properties as well as the tool orientation and position and various other drilling conditions. The orientation measurements may be performed using an azimuthal orientation indicator, which may include magnetometers, inclinometers, and/or accelerometers, though other sensor types such as gyroscopes may be used. In some embodiments, the tool includes a 3-axis fluxgate magnetometer and a 3-axis accelerometer. The electromagnetic resistivity logging tool 160 may take the form of a drill collar, i.e., a thick-walled tubular that provides weight and rigidity to aid the drilling process.

FIG. 2 is an elevation view of an illustrative wireline or slickline logging environment. At various times during the drilling process, the drill string 120 may be removed from the borehole as shown in FIG. 2. Once the drill string has been removed, logging operations can be conducted using a wireline logging tool 205, i.e., a sensing instrument sonde suspended by a cable 210 having conductors for transporting power to the tool and telemetry from the tool to the surface. An electromagnetic resistivity measuring portion of the logging tool 205 may have centralizing arms 215 that center the tool within the borehole as the tool is pulled uphole. The centralizing arms 215 may be equipped with sensor pads that are maintained in close contact with the borehole wall to gather logging data. A logging facility 220 collects measurements from the logging tool 210, and includes computing facilities for processing and storing the measurements gathered by the logging tool.

This disclosure generally relates to the design of electromagnetic resistivity tools used in LWD and MWD systems and specially relates to methods of shielding antennae for transmitting or receiving electromagnetic (EM) fields.

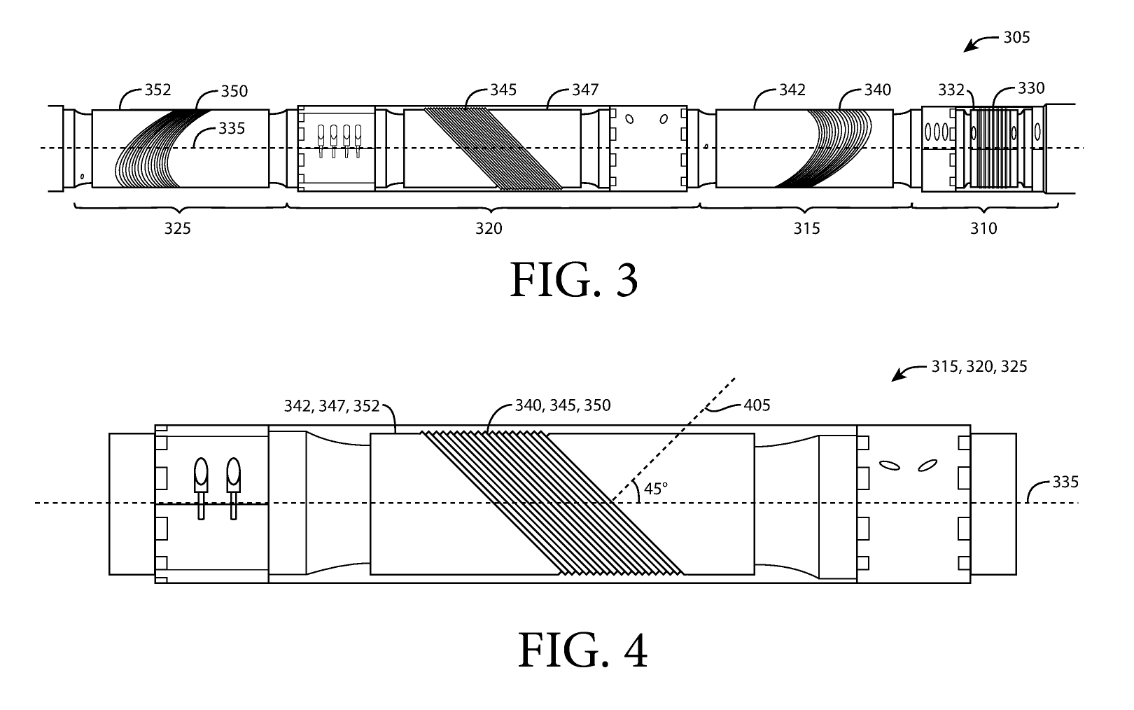

FIG. 3 is a plan view of a Geological Mapping (GM) tool sub 305 provided by Halliburton. In one or more embodiments, the GM tool sub 305 includes a plurality of GM antenna-bobbins 310, 315, 320, 325. The example in FIG. 3 consists of a first GM antenna-bobbin 310 that includes a multi-turn coaxial loop (coil) antenna 330 wound on a bobbin 332, in which the axis of the multi-turn loop antenna 330 (i.e., a line substantially perpendicular to (i.e., perpendicular within 1 degree, 2 degrees or 5 degrees) a plane containing one of the coils of the multi-turn coaxial loop antenna 330) is coincident with or substantially parallel to (i.e., parallel within 1 degree, 2 degrees or 5 degrees) a longitudinal axis 335 of the GM tool sub 305. The example in FIG. 3 also includes a plurality of GM antenna-bobbins 315, 320, 325 having multi-turn tilted loop (coil) antennae 340, 345, 350 wound on respective bobbins 342, 347, 352 that have 45° dip with respect to the axis 335 of the GM tool sub 305 and are azimuthally offset with each other by 120°.

The GM tool sub 305 can be used as a transmitter sub or a receiver sub. That is, the GM antennas 330, 340, 345, 350 can be transmitters or receivers.

In one or more embodiments, the GM tool sub 305 is spaced along the BHA with other similar GM tool subs (not shown) at nominal spacings of 25 feet, 50 feet, and 100 feet.

FIG. 4 is a plan view of one of the GM antenna-bobbins 315, 320, 325 with a tilted coil antenna 340, 345, 350. The tilted coil antennas 340, 345, 350 are oriented to generate a magnetic dipole moment with a directivity at angle of 45 degrees relative to the longitudinal axis 335 of the GM tool sub 305. This dipole directionality is realized by winding the coils 340, 345, 350 such that an axis 405 of the coils 340, 345, 350 is at 45 degree angle relative to the longitudinal axis 335 of the GM tool sub 305.

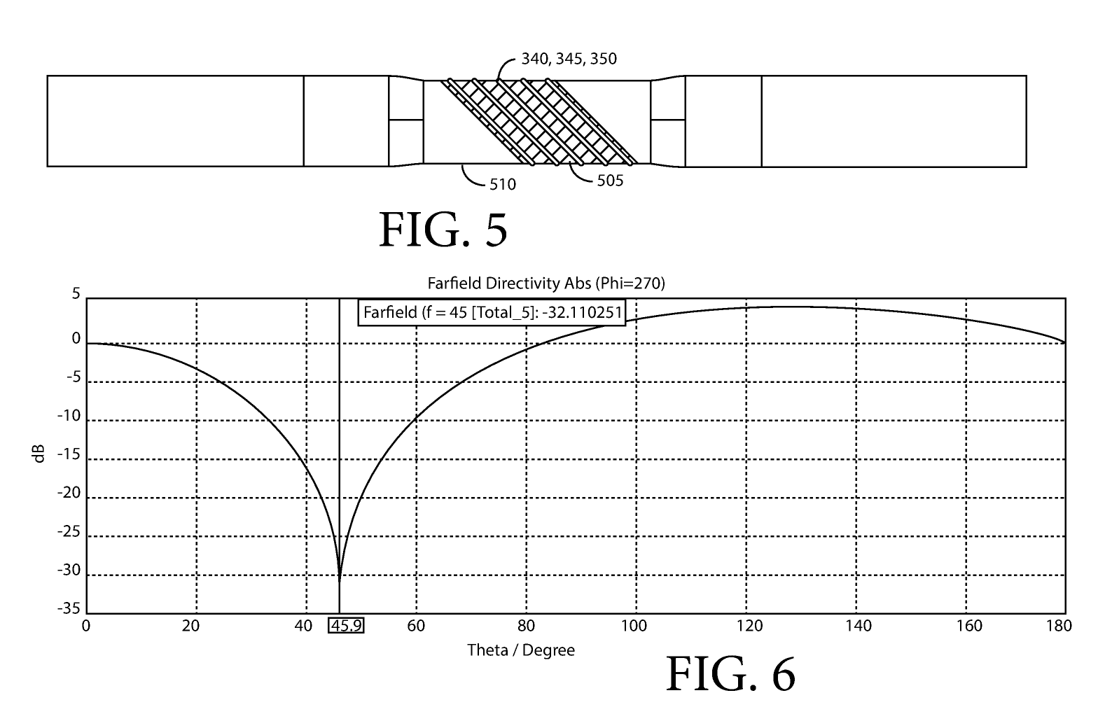

FIG. 5 is a plan view of the GM antenna-bobbins 315, 320, 325 of FIG. 4 with the bobbin 342, 347, 352 removed to show a soft magnetic material (e.g. ferrite, laminated permalloy, mu metal, metallic glass) 505 placed between the coil 340, 345, 350 (only the inner-most windings of the coil 340, 345, 350 are shown in FIG. 5) and the tool body 510, which increases the inductance of the coils 340, 345, 350. To preserve the dipole directionality at 45 degrees relative to the tool axis, the soft magnetic material 505 is aligned in strips substantially perpendicular (i.e., within 5 degrees, 10 degrees, or 15 degrees) to the coil 340, 345, 350.

FIG. 6 is a chart illustrating the directionality of the dipole created by the coil antenna 340, 345, 350 of FIG. 5. The directionality shows the effective farfield angle of the coil antenna 340, 345, 350 is 45.9 degrees.

Previous disclosures have described protecting the coil antenna 340, 345, 350 by coating it in a polymer (e.g., polyether ether ketone (PEEK)), a polymer-ceramic blend, or a ceramic). The advantage of such a material is that it has high mechanical strength and is electrically resistive and it protects the antenna system (defined to be the coil antenna 340, 345, 350, the soft magnetic material 505) while not unduly attenuating the EM fields transmitted or received. However, in extremely harsh downhole drilling conditions, such non-metallic materials may still be easily wear out. As a result, a transmissive metallic shield may be a better choice for the mechanical protection of coil antennas.

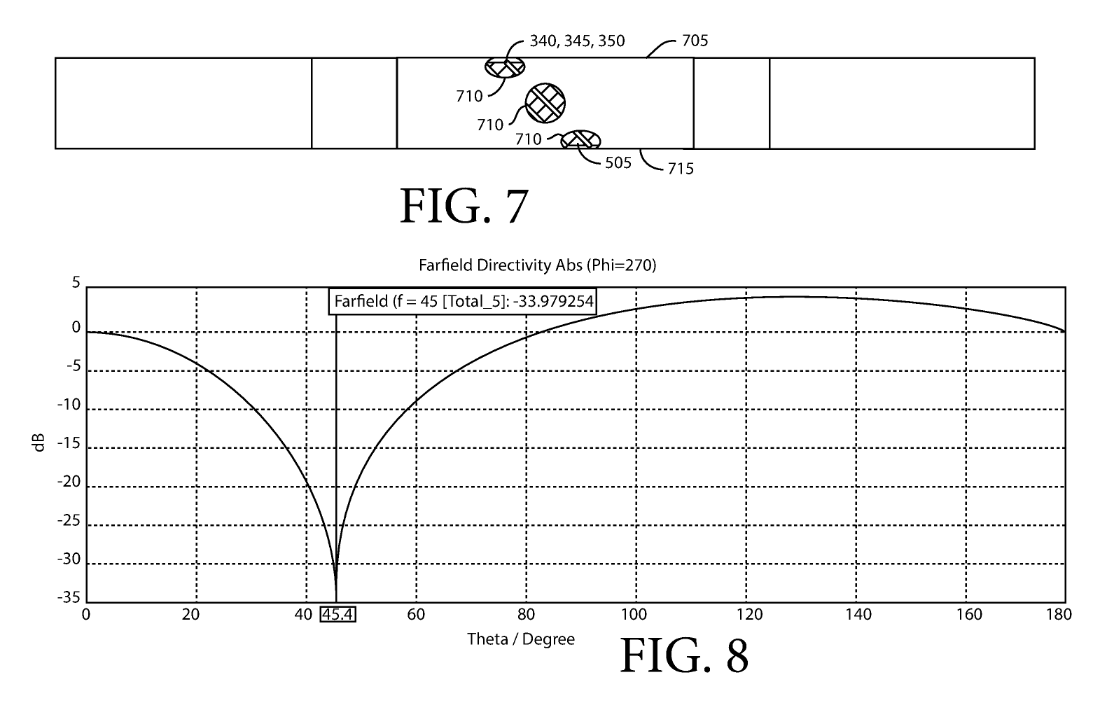

In this disclosure, an electromagnetically transmissive shield 705, 905, 1105, 1305, 1505, 1705 described below in connection with FIGS. 7, 9, 11, 13, 15, and 17, is placed around the tool body 510, protecting the coil antenna 340, 345, 350 and the soft magnetic material 505 from the harsh downhole environment. The electromagnetically transmissive shield 705, 905, 1105, 1305, 1505, 1705 has a longitudinal axis that, when installed as described below, substantially coincides (i.e., is parallel within 1, 5, or 10 degrees) with the longitudinal axis 335 of the GM tool sub 305. The electromagnetically transmissive metal shield includes a periodic array of circular or square holes cut into a metallic cylinder that covers the antenna system. The circular or square holes are of such a position and/or size so as to not significantly attenuate EM fields or materially change the directionality of the directional antenna. A circular hole is defined to have a circumferential surface that is, at all points, within 0.1, 0.5, or 1.0 percent of a radius of a circular cylinder. A square hole is defined to have a circumferential surface that is, at all points, within 0.1, 0.5, or 1.0 percent of an edge of a square cylinder.

Square slots and circular slots have the characteristic that their dimensions measured along two perpendicular axes through the centroid of the slots are equal. That is, the dimensions along two axes that go through the centroid (or center) of a circle (i.e., the radius or diameter of the circle) are equal. Similarly, the dimensions along two axes that go through the centroid of a square (e.g., the length of two adjacent sides of the square) are equal. Here, square and circle shapes are nominated as examples because of their simple structure. However, other polygon shapes which have multiple equal axes going through the centroid, such as a cross, hexagon, etc., may also be used and are interchangeable with the square and circular shapes described below.

The circular or square holes cut into the metal cylinder that cover the antenna system are aligned in a periodic array that is periodic axially and periodic azimuthally relative to the longitudinal axis 335 of the GM tool sub 305. An array of circular or square holes is axially periodic relative to the longitudinal axis 335 of the GM tool sub 305 if perpendicular projections of the centroids of the circular or square holes onto the longitudinal axis 335 of the GM tool sub 305 are evenly spaced along the longitudinal axis 335 of the GM tool sub 305. An array of circular or square holes is azimuthally periodic relative to the longitudinal axis 335 of the GM tool sub 305 if the centroids of the circular or square holes are evenly spaced azimuthally around the longitudinal axis 335 of the GM tool sub 305.

FIG. 7 is a plan view of an electromagnetically transmissive shield 705. Note that, for clarity of presentation and to show the relationship between the holes in the shield discussed below and the coils 340, 345, 350 and the soft magnetic material 505, only the innermost winding of the coil antenna 340, 345, 350 is visible in FIGS. 7, 9, 11, 13, 15, 17, 19, 21, 23, and 25. In one or more embodiments, the electromagnetic shield 705 includes one line of circular holes 710 cut into a metal cylinder 715 that covers the antenna system. The circular holes 710 trace the coil antenna 340, 345, 350. That is, a projection of a curve through the centroids of the circular holes 710 onto the soft magnetic material 505 follows a substantially (i.e., within 2, 5, or 10 percent) parallel path to the coil antenna 340, 345, 350. The coil antenna 340, 345, 350 is tilted at 45 degrees and there are six circular holes 710 equally spaced azimuthally each having a radius of 40 millimeters (mm). The circular holes 710 are azimuthally periodic and axially periodic.

FIG. 8 is a chart illustrating the directionality of the antenna system with the electromagnetically transmissive shield 705 shown in FIG. 7. As can be seen, dipole directionality is preserved near 45 degrees.

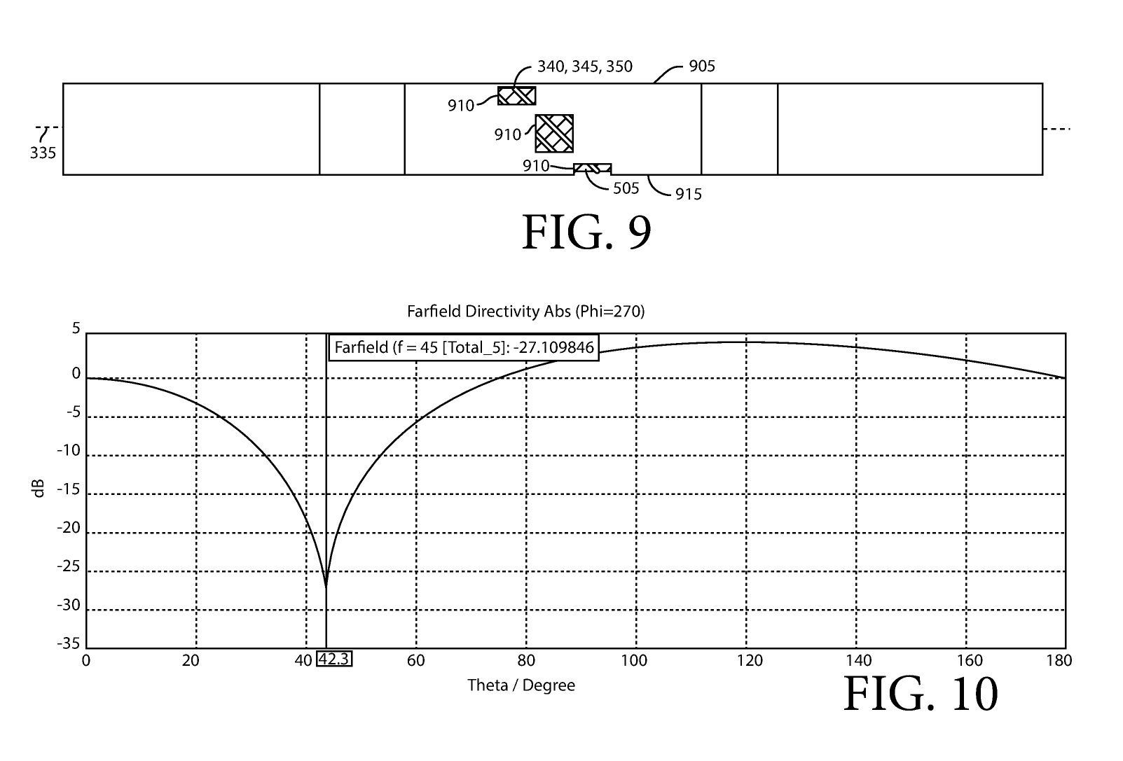

FIG. 9 shows an electromagnetically transmissive shield 905 including one line of square holes 910 cut into a metal cylinder 915 that covers the antenna system. The square holes 910 are aligned with the tool axis (i.e., the edges of the square holes 910 are parallel to or perpendicular to, within 2, 5, or 10 degrees, the tool axis 335) and trace the coil. The thickness of the metal cylinder 915 is 2 mm, the coil antenna 340, 345, 350 is tilted at 45 degrees, and there are six 40 mm×40 mm square holes 910. The square holes 910 are azimuthally periodic and axially periodic.

FIG. 10 is a chart illustrating the directionality of the antenna system with the electromagnetically transmissive shield 905 shown in FIG. 9. As can be seen, dipole directionality near 45 degrees is preserved.

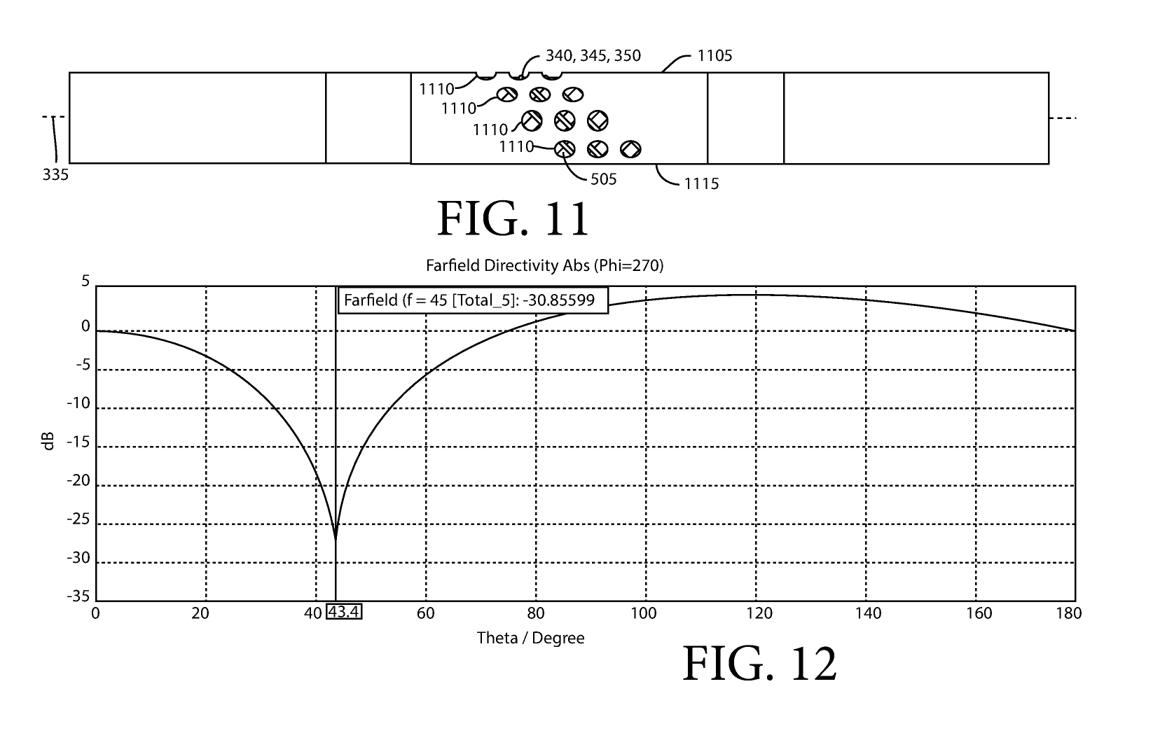

FIG. 11 is a plan view of an electromagnetically transmissive shield 1105 including two or more rows of circular holes 1110 cut into a metal cylinder 1115 that covers the antenna system. The circular holes 1110 trace the coil antenna 340, 345, 350. The coil antenna 340, 345, 350 is tilted at 45 degrees. The metal cylinder 1115 is 2 mm thick. There are 3 bands of 9 circular holes 1110 that are azimuthally and axially periodic. Each of the circular holes 1110 has a radius of 20 mm.

FIG. 12 is a chart illustrating the directionality of the antenna system with the electromagnetically transmissive shield 1105 shown in FIG. 11. As can be seen, dipole directionality near 45 degrees is preserved.

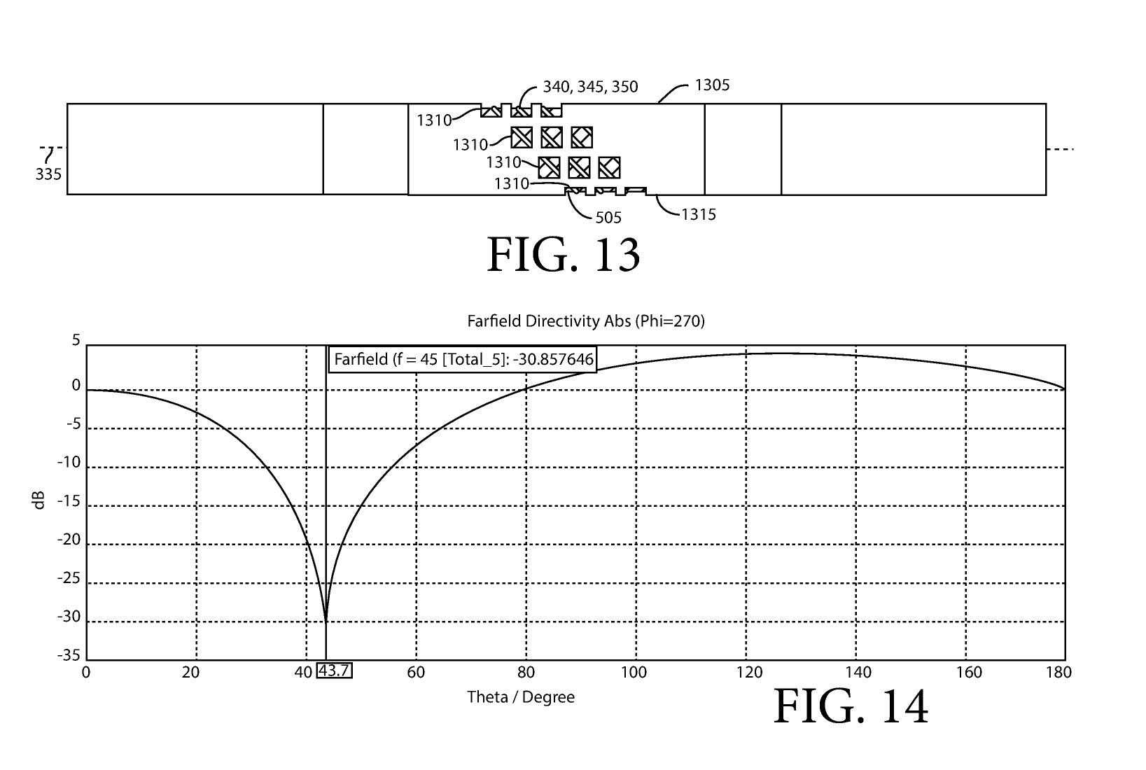

FIG. 13 is a plan view of an electromagnetically transmissive shield 1305 including two more rows of square holes 1310 cut into a metal cylinder 1310 that covers the antenna system, where the square holes are aligned with the tool axis 335 and trace the coil antenna 340, 345, 350. The coil antenna 340, 345, 350 is tilted at 45 degrees. The metal cylinder 1310 is 2 mm thick. There are 3 bands of nine 20 mm×20 mm square holes 1310 that are azimuthally and axially periodic.

FIG. 14 is a chart illustrating the directionality of the antenna system with the electromagnetically transmissive shield 1305 shown in FIG. 13. As can be seen, dipole directionality near 45 degrees is preserved.

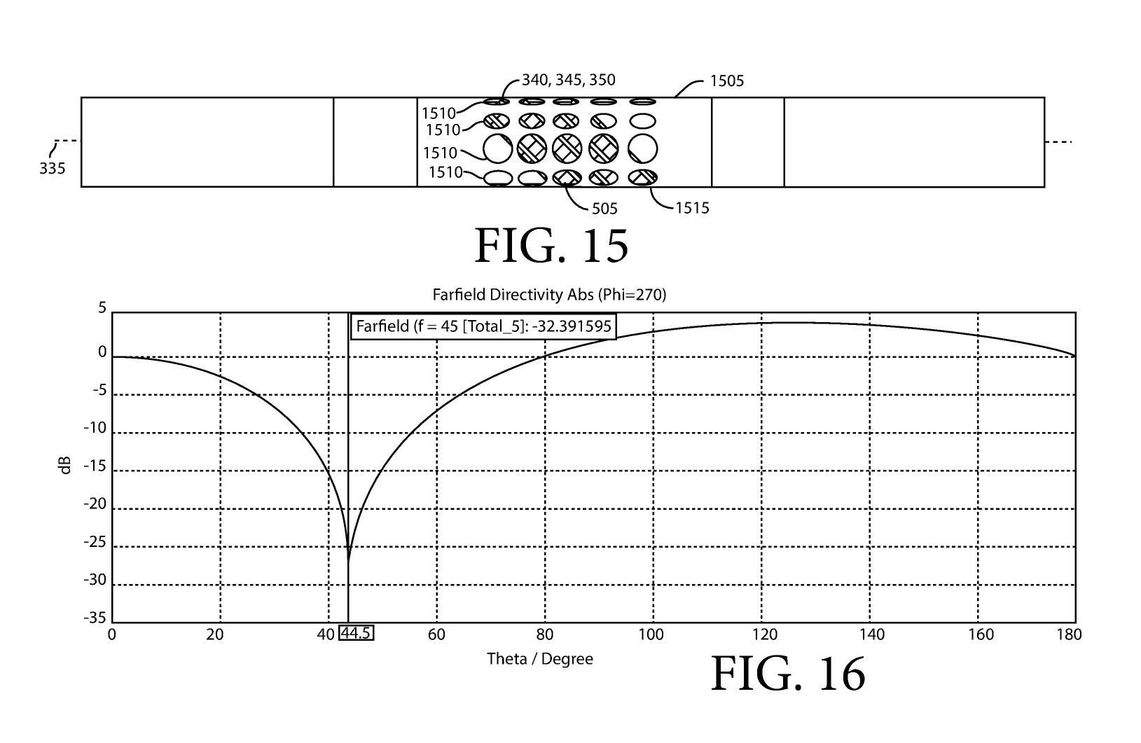

FIG. 15 is a plan view of an electromagnetically transmissive shield 1505 including a periodic array of circular holes 1510 cut into a metal cylinder 1515 that covers the antenna system. The coil antenna 340, 345, 350 is tilted at 45 degrees. There are 5 bands of 9 circular holes 1510 that are azimuthally perioidic and axially periodic. Each of the circular holes has a radius of 20 mm. The thickness of the metal cylinder 1515 is 2 mm.

FIG. 16 is a chart illustrating the directionality of the antenna system with the electromagnetically transmissive shield 1505 shown in FIG. 15. As can be seen, dipole directionality near 45 degrees is preserved.

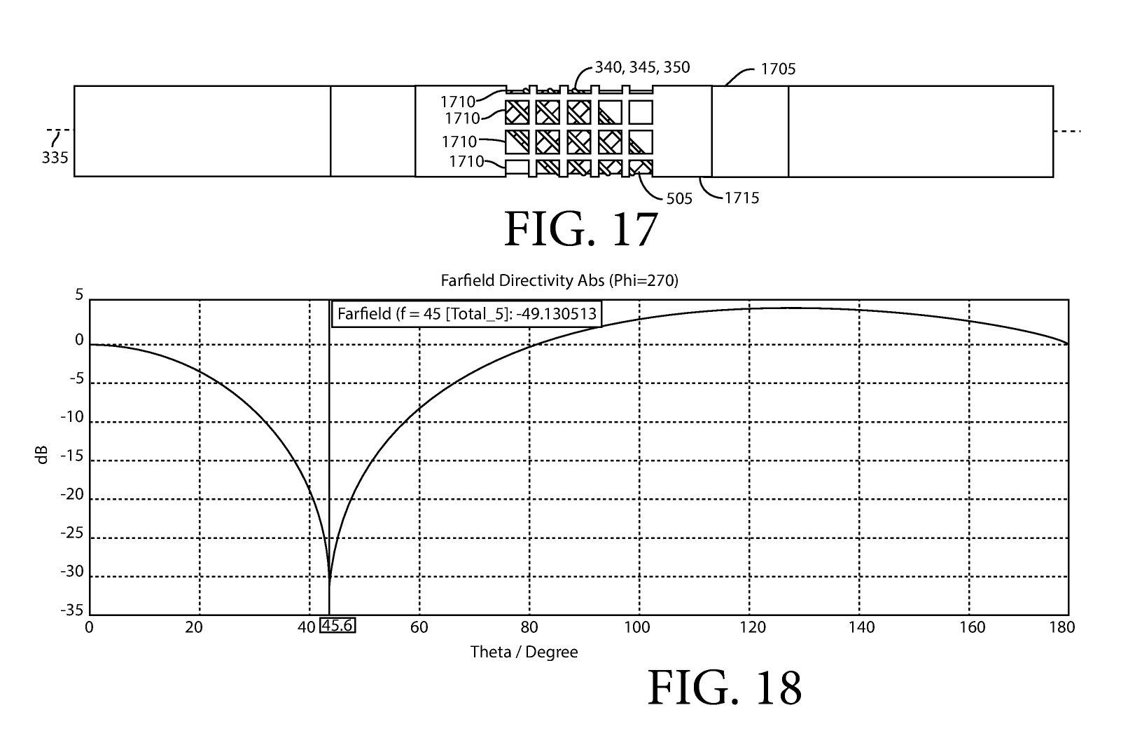

FIG. 17 is a plan view of an electromagnetically transmissive shield 1705 including a periodic array of square holes 1710 cut into a metal cylinder 1715 that covers the antenna system, where the square holes 1710 are aligned with the tool axis. The coil antenna 340, 345, 350 is tilted at 45 degrees. There are 5 bands of nine 20 mm×20 mm square holes 1710 that are azimuthally and axially periodic. The thickness of the metal cylinder 1715 is 2 mm.

FIG. 18 is a chart illustrating the directionality of the antenna system with the electromagnetically transmissive shield 1705 shown in FIG. 17. As can be seen, dipole directionality near 45 degrees is preserved.

In one or more embodiments, the metal shield 915, 1115, 1315, 1515, 1715 is fabricated from any suitable metal or alloy (e.g., Inconel alloy).

In one or more embodiments, the volume between the coil 340, 345, 350 and the inner surface of the shield 915, 1115, 1315, 1515, 1715 is filled with an electrically resistive and mechanically strong material, such as PEEK.

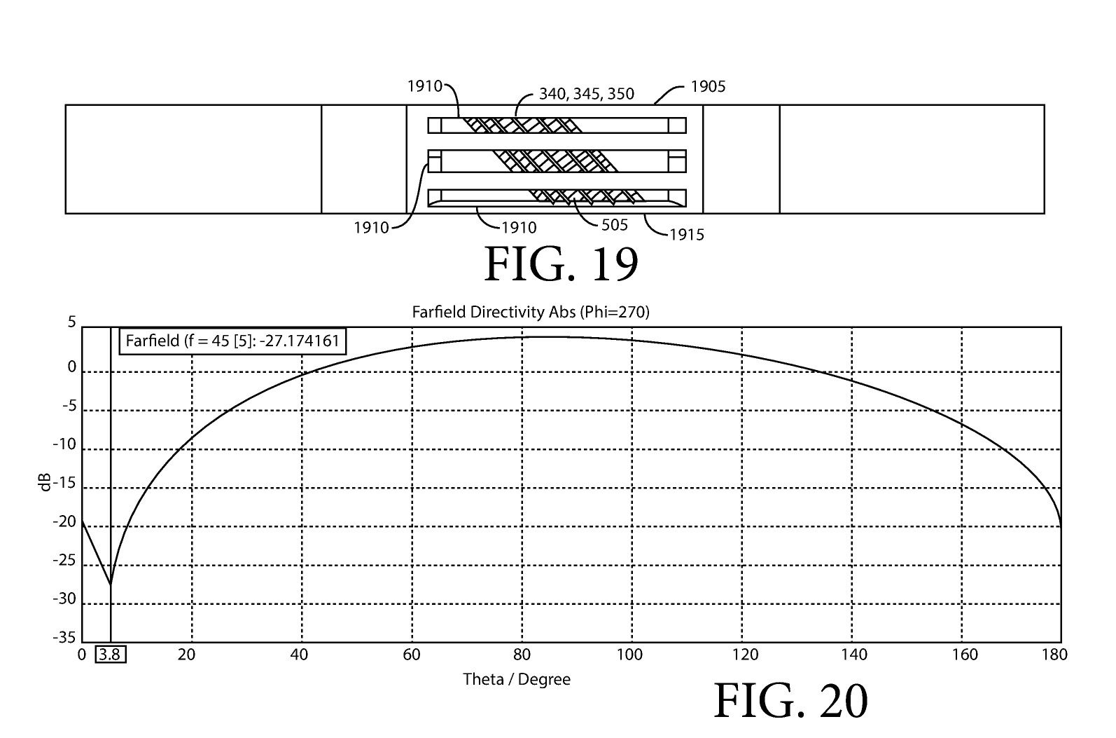

Dipole directivity may not be preserved with other transmissive shield designs, as illustrated in FIGS. 19-26.

FIG. 19 is a plan view of an electromagnetic transmissive shield 1905 consisting of multiple axially-aligned slots 1905 cut into a metal cylinder 1910. The slots 1905 are 320 mm long and 20 mm wide (i.e., the slots 1905 are not square) and are azimuthally periodic but not axially periodic (i.e., all of the slots 1905 are at the same point on the longitudinal axis 335). The thickness of the metal cylinder is 2 mm.

FIG. 20 is a chart illustrating the directionality of the antenna system with the electromagnetically transmissive shield 1905 shown in FIG. 19. As can be seen, the dipole directionality of 45 degrees is not preserved in this arrangement but is instead is approximately 4 degrees.

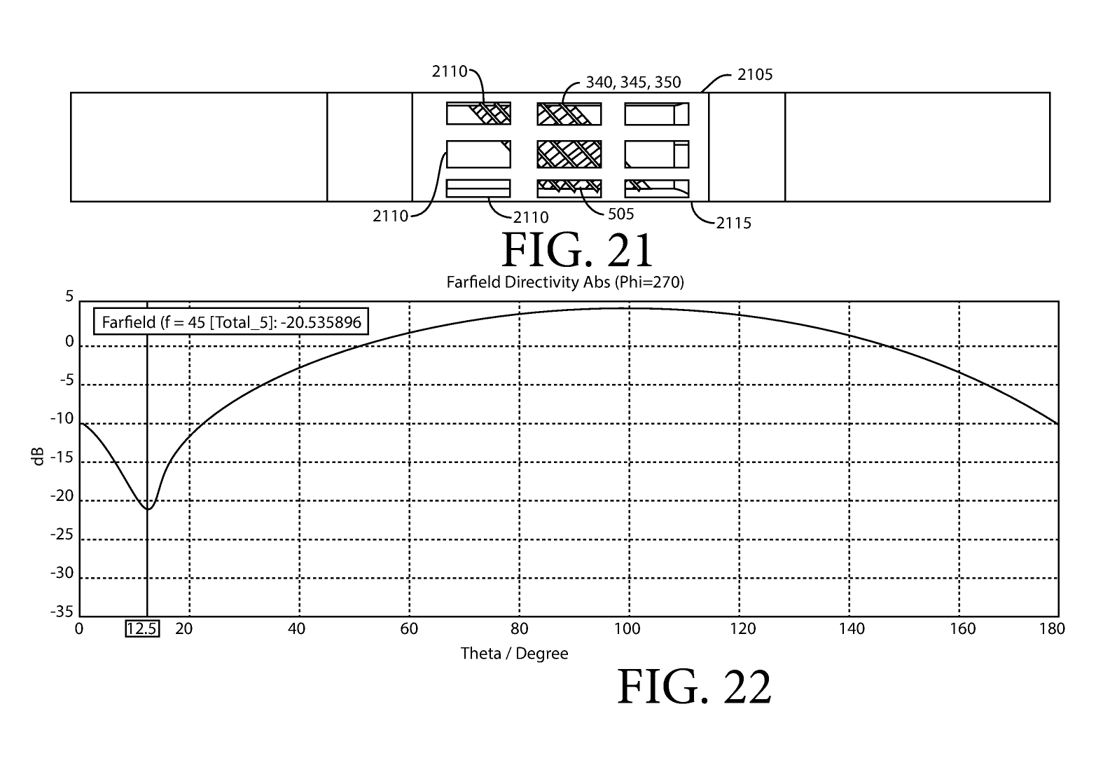

FIG. 21 is a plan view of an electromagnetic transmissive shield 2105 consisting of three rows of nine rectangular slots 2110 cut into a metal cylinder 2115. The rectangular slots 2110 are 80 mm in length and 20 mm wide (i.e., the slots 2105 are not square) and are azimuthally periodic and axially periodic. The thickness of the metal cylinder 2110 is 2 mm.

FIG. 22 shows the directionality of the antenna system with the electromagnetically transmissive shield 2105 shown in FIG. 21. As can be seen, dipole directionality of 45 degrees is not preserved but is instead approximately 13 degrees.

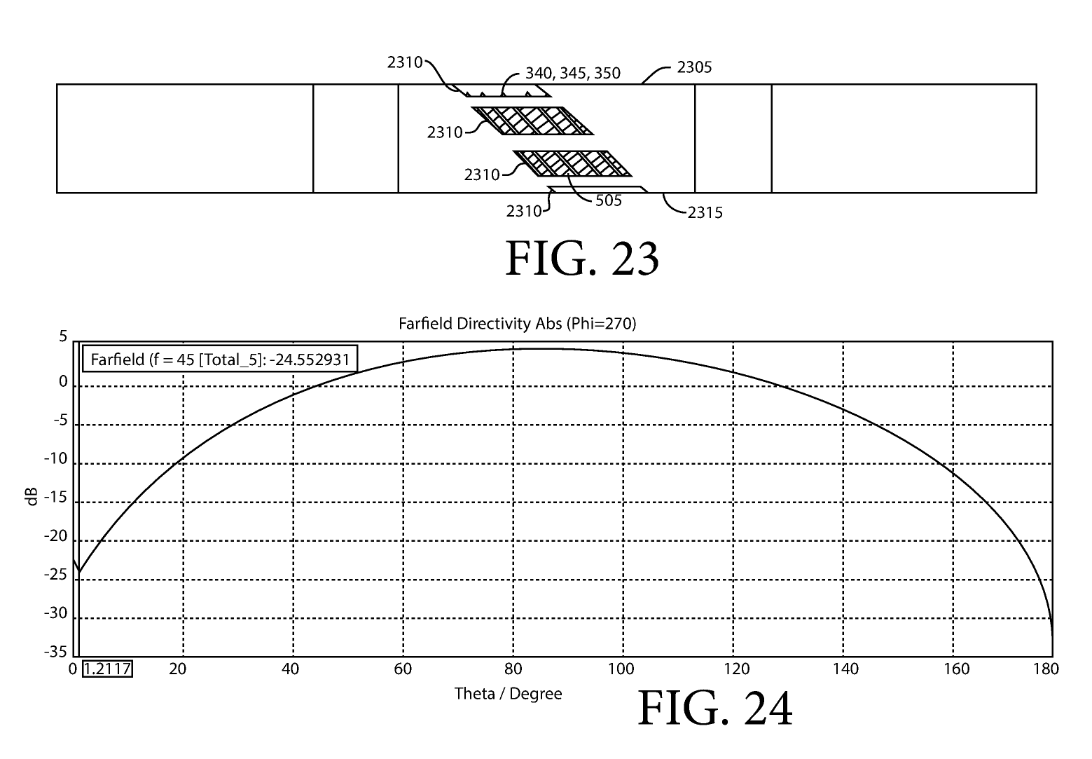

FIG. 23 is a plan view of an electromagnetic transmissive shield 2305 consisting of a row of 9 slots 2310 cut into a metal cylinder 2315. The slots 2305 are parallelograms (i.e., not squares), with two 80 mm sides and two 20 mm sides. The slots 2305 are azimuthally periodic and axially periodic. The thickness of the metal cylinder 2310 is 2 mm.

FIG. 24 is a chart illustrating the directionality of the antenna system with the electromagnetically transmissive shield shown in FIG. 23. As can be seen, dipole directionality of 45 degrees is not preserved but is instead approximately 1 degree.

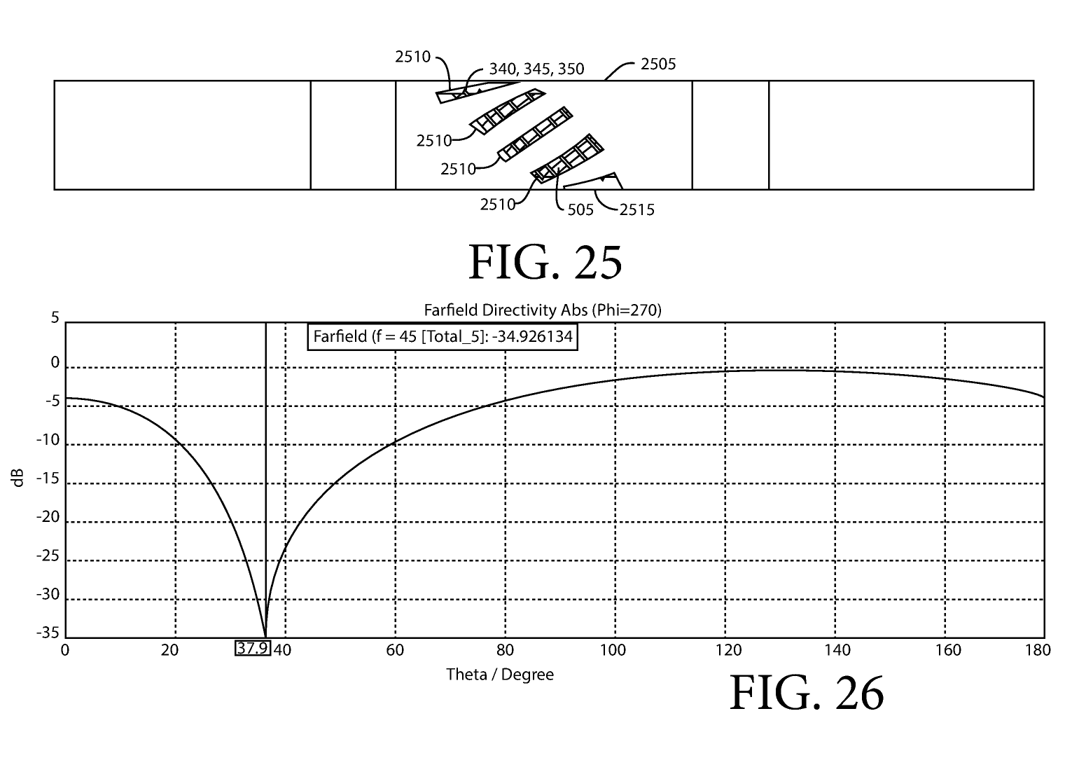

FIG. 25 is a plan view of an electromagnetic transmissive shield 2505 consisting of a band of curved rectangular slots 2510 cut into a metal cylinder 2515. The slots 2510 are axially periodic and azimuthally periodic. The rectangular slots 2505 are 80 mm in length and 12 mm in width. The thickness of the metal cylinder 2510 is 2 mm.

FIG. 26 is a chart illustrating the directionality of the antenna system with the electromagnetically transmissive shield shown in FIG. 25. As can be seen, dipole directionality may be preserved by this design (approximately 38 degrees). However, since this design involves curved slots on the shield, it may increase the mechanical difficulty for manufacturing and machining.

In one aspect, an apparatus includes a metal cylinder defining a longitudinal axis and having a plurality of slots. Each slot has the same dimensions along two perpendicular axes through a centroid of the slot. The plurality of slots is azimuthally periodic relative to the longitudinal axis of the metal cylinder and axially periodic relative to the longitudinal axis of the metal cylinder.

Implementations may include one or more of the following. The plurality of slots may include square slots. The plurality of slots may include circular slots. The plurality of slots may include a single row of slots. The plurality of slots may include two or more rows of slots.

In one aspect, an apparatus includes an antenna system to generate an electromagnetic field with a desired magnitude and in a desired direction. The apparatus includes a shield to protect the antenna system. The shield has a metal cylinder having a longitudinal axis and a plurality of slots. Each slot has the same dimensions along two perpendicular axes through a centroid of the slot. The plurality of slots is azimuthally periodic relative to the longitudinal axis of the metal cylinder and axially periodic relative to the longitudinal axis of the metal cylinder.

Implementations may include one or more of the following. The antenna system may include a coil of wire wound at an angle of substantially 45 degrees with respect to the longitudinal axis of the metallic cylinder. The plurality of slots may be arranged along a curve substantially parallel to the coil. The plurality of slots may include square slots. The plurality of slots may include circular slots. The plurality of slots may include a single row of slots. The plurality of slots may include two or more rows of slots.

In one aspect, an apparatus includes an antenna system to generate an electromagnetic field with a desired magnitude and in a desired direction. The apparatus includes a shield to protect the antenna system having a metal cylinder defining a longitudinal axis and having a plurality of slots. The slots are sized and positioned so that the antenna system with the shield generates an electromagnetic field with substantially the desired magnitude in substantially the desired direction.

Implementations may include one or more of the following. The plurality of slots may be azimuthally periodic relative to the longitudinal axis of the metallic cylinder. The plurality of slots may be axially periodic relative to the longitudinal axis of the metallic cylinder. The plurality of slots may include square slots. The plurality of slots may include circular slots. The plurality of slots may include a single row of slots. The plurality of slots may include two or more rows of slots.

In one aspect, a method includes forming a plurality of slots in a metal cylinder having a longitudinal axis. Each slot has the same dimensions along two perpendicular axes through a centroid of the slot. The plurality of slots are azimuthally periodic relative to the longitudinal axis of the metal cylinder and azimuthally periodic relative to the longitudinal axis of the metal cylinder.

Implementations may include one or more of the following. The method of claim 18 wherein forming the plurality of slots may include forming square slots. Forming the plurality of slots may include forming circular slots. Forming the plurality of slots may include forming a single row of slots. Forming the plurality of slots may include forming two or more rows of slots.

In one aspect, a method includes creating a shield by forming a plurality of slots in a metal cylinder having a longitudinal axis. Each slot has the same dimensions along two perpendicular axes through a centroid of the slot. The plurality of slots are azimuthally periodic relative to the longitudinal axis of the metal cylinder and axially periodic relative to the longitudinal axis of the metal cylinder. The method includes positioning the shield around an antenna system.

Implementations may include one or more of the following. The antenna system may include a coil of wire wound at an angle of substantially 45 degrees with respect to the longitudinal axis of the metallic cylinder. The plurality of slots may be arranged along a curve substantially parallel to the coil. The plurality of slots may include square slots. The plurality of slots may include circular slots. The plurality of slots may include a single row of slots. The plurality of slots may include two or more rows of slots. The method may include coupling the combined antenna system and shield to a drill string in a measurement-while-drilling system. The method may include coupling additional combined antenna systems and shield to the drill string to form a resistivity measuring tool. The method may include using the resistivity tool to measure the resistivity of an underground formation.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. An apparatus comprising:
a metal cylinder defining a longitudinal axis and having a plurality of slots, each slot having the same dimensions along two perpendicular axes through a centroid of the slot, wherein
the plurality of slots is azimuthally periodic relative to the longitudinal axis of the metal cylinder and axially periodic relative to the longitudinal axis of the metal cylinder.

2. The apparatus of claim 1 wherein the plurality of slots comprises square slots.

3. The apparatus of claim 1 wherein the plurality of slots comprises circular slots.

4. The apparatus of claim 1 wherein the plurality of slots comprises a single row of slots.

5. The apparatus of claim 1 wherein the plurality of slots comprises two or more rows of slots.

6. An apparatus comprising:
an antenna system to generate an electromagnetic field with a desired magnitude and in a desired direction;
a shield to protect the antenna system, the shield having a metal cylinder;
the metal cylinder defining a longitudinal axis and having a plurality of slots; and
each slot having the same dimensions along two perpendicular axes through a centroid of the slot, wherein
the plurality of slots is azimuthally periodic relative to the longitudinal axis of the metal cylinder and axially periodic relative to the longitudinal axis of the metal cylinder.

7. The apparatus of claim 6 wherein:
the antenna system comprises a coil of wire wound at an angle of substantially 45 degrees with respect to the longitudinal axis of the metallic cylinder; and
the plurality of slots is arranged along a curve substantially parallel to the coil.

8. The apparatus of claim 6 wherein the plurality of slots comprises square slots.

9. The apparatus of claim 6 wherein the plurality of slots comprises circular slots.

10. The apparatus of claim 6 wherein the plurality of slots comprises a single row of slots.

11. The apparatus of claim 6 wherein the plurality of slots comprises two or more rows of slots.

12. An apparatus comprising:
an antenna system to generate an electromagnetic field with a desired magnitude and in a desired direction;
a shield to protect the antenna system, the shield having a metal cylinder defining a longitudinal axis and having a plurality of slots; wherein
the slots are sized and positioned so that the antenna system with the shield generates an electromagnetic field with substantially the desired magnitude in substantially the desired direction.

13. The apparatus of claim 12 wherein:
the plurality of slots is azimuthally periodic relative to the longitudinal axis of the metallic cylinder, and
the plurality of slots is axially periodic relative to the longitudinal axis of the metallic cylinder.

14. The apparatus of claim 12 wherein the plurality of slots comprises square slots.

15. The apparatus of claim 12 wherein the plurality of slots comprises circular slots.

16. The apparatus of claim 12 wherein the plurality of slots comprises a single row of slots.

17. The apparatus of claim 12 wherein the plurality of slots comprises two or more rows of slots.

18-30. (canceled)
